(19) United States
(12) Patent Application Publication
(10) Pub. No.: US 2007/0218216 A1
(43) Pub. Date: Sep. 20, 2007

(54) Light modulating material

(75) Inventors: Takashi Kato, Kanagawa (JP); Koji Takaku, Kanagawa (JP); Naoyuki Hayashi, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/717,703

(22) Filed: Mar. 14, 2007

(30) Foreign Application Priority Data
Mar. 17, 2006 (JP) 2006-075241

(51) Int. Cl. C09K 19/60; C09K 19/52; F21V 9/00; C09K 19/38

(52) U.S. Cl. 428/1.1; 252/582; 428/1.3; 252/299.1; 252/299.01

(57) ABSTRACT

The invention provides a light modulating material having at least a liquid crystal layer disposed between a pair of transparent electrodes. The liquid crystal layer has at least: a liquid crystal composition having at least one host liquid crystal having negative dielectric anisotropy and at least one dichroic dye; and at least one polymer material. The liquid crystal composition is vertically aligned when no voltage is applied, and the transmissivity of incident light of the light modulating material when no voltage is applied is higher than the transmissivity of incident light of the light modulating material when voltage is applied. The invention further provides a liquid crystal device that includes the liquid crystal layer.

### BACKGROUND OF THE INVENTION

1. Field of Invention

The invention relates to a light modulating material.

2. Description of Related Art

Together with growing concern about the environment, materials capable of electrically modulating quantities of light, or so-called electric light modulating materials have increased in importance. So far, various methods have been proposed for electric light modulating materials, including an electrochromic system making use of an oxidation/reduction reaction, and a polymer dispersion liquid crystal (PDLC) system making use of a compound system of liquid crystals and polymers. However, the electrochromic method has problems such as it being difficult to increase surface area by electric driving, and poor durability of electrochromic dyes. The PDLC system is insufficient in light modulating performance under some conditions. A further proposal is a light modulating material using a guest-host system combining a dichroic dye and a host liquid crystal.

These light modulating materials are usually colored or scattered when no voltage is applied. When voltage is applied, the light modulating materials become transparent. Considering actual use, however, it is preferable that light modulating materials are transparent when no voltage is applied, from the viewpoint of reducing power consumption. Hence, there is great interest in the development of light modulating materials which are transparent when no voltage is applied. As such a light modulating material, the PDLC system has been proposed (see, for example, U.S. Pat. No. 5,056,898); however, its light modulating performance is insufficient under some conditions.

### SUMMARY OF THE INVENTION

The invention provides a light modulating material which is transparent when no voltage is applied.

In light modulating materials using an ordinary liquid crystal composition, it has been difficult to obtain a light modulating material or liquid crystal display device with a satisfactory display performance, which is also transparent when no voltage is applied. The inventor has conducted intensive research and development, and has discovered that a light modulating material or liquid crystal display device, which is transparent when no voltage is applied, and which is capable of exhibiting a very high light modulating performance, can be realized by combining a specific liquid crystal composition and a polymer material. The inventor has completed the invention by further accumulating studies on the basis of this finding.

Namely, the invention provides a light modulating material comprising a liquid crystal layer disposed between a pair of transparent electrodes, wherein the liquid crystal layer comprises: a liquid crystal composition comprising at least one host liquid crystal having negative dielectric anisotropy and at least one dichroic dye; and at least one polymer material, the liquid crystal composition is vertically aligned when no voltage is applied; and the transmissivity of incident light of the light modulating material when no voltage is applied is higher than the transmissivity of incident light of the light modulating material when voltage is applied.

In the invention, the liquid crystal layer, that contains at least the host liquid crystal that is negative in dielectric anisotropy, the polymer material, and the dichroic dye, is vertically aligned when no voltage is applied, and transmissivity of incident light is high when no voltage is applied. This mode is shown in FIG. 1A and FIG. 1B. FIG. 1A shows the alignment state of the liquid crystal composition when no voltage is applied, and FIG. 1B shows the alignment state of the liquid crystal composition when voltage is applied.

The light modulating material of the invention relates to a light modulating material having a liquid crystal layer 12 disposed between a pair of transparent electrodes 10. The liquid crystal material 12 contains a liquid crystal composition 14, and a polymer material 16, and the liquid crystal composition 14 further contains liquid crystal molecules 18, and dichroic dye 20.

In the invention, when no voltage is applied, liquid crystal molecules 18 are vertically aligned to the transparent electrode 10 as shown in FIG. 1A, and the dichroic dyes 20 are also vertically aligned. When materials are selected so that the refractive index (n∥) of liquid crystal molecule 18 in the major axis direction is as close as possible to the refractive index (np) of polymer material 16, the refractive index difference between liquid crystal composition 14 and polymer material 16 is small, and light is transmitted without being scattered. That is, a transparent state is achieved.

When the order parameter of dichroic dye 20 is positive, it is colorless and transparent in the alignment state of FIG. 1A, where a dichroic dye with a negative order parameter would be in a colored transparent state.

When voltage is applied, on the other hand, since the liquid crystal molecules 18 have a negative dielectric anisotropy, the liquid crystal molecules 18 are aligned horizontally to the transparent electrode 10, and the dichroic dye 20 is also aligned horizontally, as shown in FIG. 1B. Since the liquid crystal molecules 18 have a refractive anisotropy (Δn), a difference occurs between the refractive index (n⊥) of liquid crystal molecule 18 in the minor axis direction and the refractive index (np) of polymer material 16, and the light is scattered.

When the order parameter of dichroic dye 20 is positive, it is colored and scattered in the alignment state of FIG. 1B, where a dichroic dye with a negative order parameter would be in a colorless scattered state.

Therefore, according to the light modulating material of the invention, by combination of dichroic dyes used, a light modulating material is obtained that can be switched between a colorless transparent state and a colored scattered state, and between a colored transparent state and a turbid state (scattered state). In any of the above combinations, since the light modulating material is transparent when no voltage is applied, power consumption can be reduced.

In one preferable embodiment of the invention, the polymer material in the liquid crystal layer of the light modulating material has a mesogen that has a positive dielectric anisotropy and is disposed at a side chain of the polymer.

FIG. 2A and FIG. 2B show an aspect of the invention using a polymer material having a mesogen of positive dielectric anisotropy at a side chain thereof.

When no voltage is applied as shown in FIG. 2A, liquid crystal molecules 18 are vertically aligned to the transparent electrode 10, and the dichroic dye 20 is also vertically aligned. Further, the polymer material 16 is also vertically aligned due to an alignment layer or the like. When materials are selected so that the refractive index (n∥) of liquid crystal molecule 18 in the major axis direction is as close as possible to the refractive index (np∥) of polymer material 16 in the major axis direction, the refractive index difference between liquid crystal composition 14 and polymer material 16 becomes small, and light is transmitted without being scattered. That is, a transparent state is achieved.

When the order parameter of dichroic dye 20 is positive, it is colorless and transparent in the alignment state of FIG. 2A, where a dichroic dye with a negative order parameter would be in a colored transparent state.

When voltage is applied, however, since the liquid crystal molecules 18 have a negative dielectric anisotropy, liquid crystal molecules 18 are aligned horizontally to the transparent electrode 10, as shown in FIG. 2B, and the dichroic dye 20 is also aligned horizontally. Further, the polymer material 16 has a mesogen 21 of positive dielectric anisotropy at the side chain, and thus, by application of voltage, a more uniform vertically aligned state is achieved. In this state, therefore, the liquid crystal molecules 18 are aligned horizontally, and the polymer material 16 is vertically aligned, and the difference in refractive index is large, making scattering more intensified.

When the order parameter of dichroic dye 20 is positive, it is colored and scattered in the alignment state of FIG. 2B, where a dichroic dye with a negative order parameter would be in a colorless scattered state.

Therefore, according to the invention in the above embodiment, because the scattered state is intensified by application of voltage, the ratio of light transmissivity between the transparent state and scattered state is increased, enhancing the light modulating performance.

In another preferable embodiment of the invention, the dichroic dye has a substituent represented by the following Formula (1).

-(Het)ⱼ-{(B¹)ₚ-(Q¹)_{q}-(B²)ᵣ}ₙ—C¹ Formula (1):

In Formula (1), Het represents an oxygen atom or a sulfur atom. Each of B¹ and B² independently represents an arylene group, a heteroarylene group, or a divalent cyclic aliphatic hydrocarbon group. Q¹ represents a divalent coupler. C¹ represents an alkyl group, a cycloalkyl group, an alkoxy group, a alkoxy carbonyl group, an acyl group, or an acyloxy group. j represents 0 or 1. Each of p, q and r independently represents an integer from 0 to 5. n represents an integer from 1 to 3. (p+r)×n is an integer from 3 to 10. When p, q, or r is 2 or more, two or more of B¹, Q¹ and B² may be the same as or different from each other. When n is 2 or more, two or more of {(B¹)ₚ-(Q¹)_{q}-(B²)ᵣ} may be the same as or different from each other.

In the above embodiment of the invention, a dichroic dye having a substituent represented by Formula (1) is used. This dichroic dye has a positive order parameter, and thus the light modulating material using such a dichroic dye can be switched between a colorless transparent state and a colored scattered state.

This dichroic dye absorbs a large amount of light in a horizontal alignment direction; consequently a light modulating material with a high level of coloration achieved through application of voltage can be realized.

The invention further provides a liquid crystal device comprising a liquid crystal layer disposed between a pair of electrodes comprising at least one transparent electrode, wherein the liquid crystal layer comprises: a liquid crystal composition comprising at least one host liquid crystal having negative dielectric anisotropy and at least one dichroic dye; and at least one polymer material, the liquid crystal composition is vertically aligned when no voltage is applied; and the transmissivity of incident light of the light modulating material when no voltage is applied is higher than the transmissivity of incident light of the light modulating material when voltage is applied.

The liquid crystal device of the invention relates to a liquid crystal display device in which a liquid crystal layer negative in dielectric anisotropy and containing a host liquid crystal, a polymer material, and a dichroic dye, is vertically aligned when no voltage is applied, and transmissivity of incident light is high when no voltage is applied. The driving principle of the liquid crystal device is the same as that in the above-described light modulating material of the invention. Conditions for preferable embodiments of the liquid crystal device are also similar to those of the light modulating material.

### BRIEF DESCRIPTION OF THE DRAWINGS

FIG. 1A shows the alignment state of the liquid crystal composition contained in the liquid crystal layer of the light modulating material of the invention, when no voltage is applied.

FIG. 1B shows the alignment state of the liquid crystal composition contained in the liquid crystal layer of the light modulating material of the invention, when voltage is applied.

FIG. 2A shows the alignment state of the liquid crystal composition contained in the liquid crystal layer of the light modulating material of the invention, when it has a polymer material with a mesogen having positive dielectric anisotropy at the side chain, when no voltage is applied.

FIG. 2B shows the alignment state of the liquid crystal composition contained in the liquid crystal layer of the light modulating material of the invention, when it has a polymer material with a mesogen having positive dielectric anisotropy at the side chain, when voltage is applied.

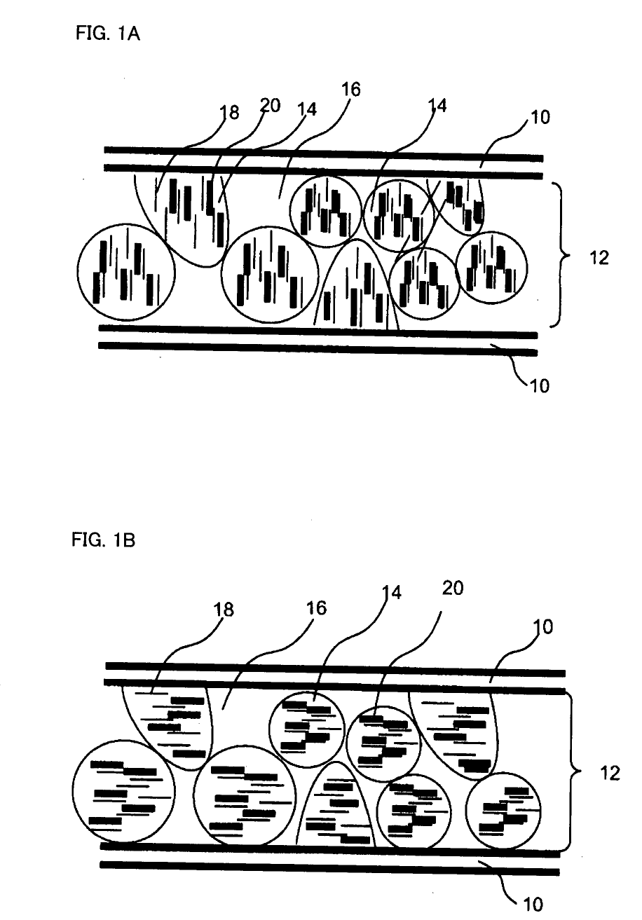

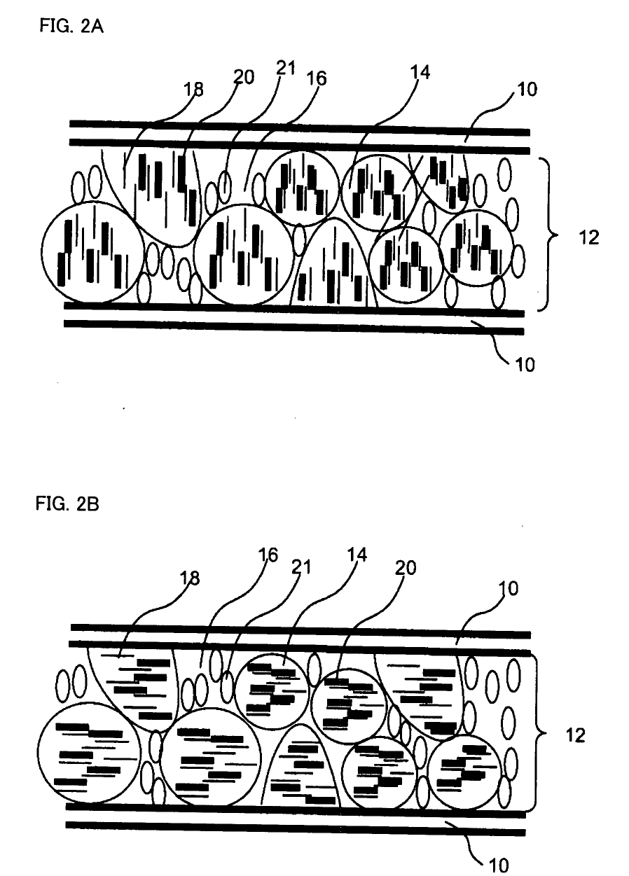

### DETAILED DESCRIPTION OF THE INVENTION

The invention is described in detail below. In the specification, the expression “a range of N_{A} to N_{B}” means a range including a numerical value N_{A} as the minimum value, and a numerical value N_{B} as the maximum value.

Each of the light modulating material and the liquid crystal device of the invention has at least a liquid crystal layer disposed between a pair of transparent electrodes. The liquid crystal layer has at least: a liquid crystal composition having at least one host liquid crystal having negative dielectric anisotropy and at least one dichroic dye; and at least one polymer material. The liquid crystal composition is vertically aligned when no voltage is applied, and the transmissivity of incident light of the light modulating material when no voltage is applied is higher than the transmissivity of incident light of the light modulating material when voltage is applied.

In the specification, the “liquid crystal composition” contains at least the dichroic dye, and the host liquid crystal, and may further contain other additives. The liquid crystal layer contains at least the liquid crystal composition and polymer material.

The light modulating materials and composition used in the liquid crystal of the invention are described below.

### Host Liquid Crystal

The liquid crystal composition usable in the invention is negative in dielectric anisotropy. Examples of the liquid crystal composition usable in the invention include a nematic liquid crystal and a smectic liquid crystal. In particular, a nematic liquid crystal compound is preferable. When the liquid crystal composition usable in the invention has a nematic phase, as compared with the case of having a cholesteric phase or a smectic phase, a lower voltage is needed for changing its alignment state. That is, because the voltage required for changing the alignment state is lower with a nematic liquid crystal than with a cholesteric or smectic liquid phase, power consumption can be further reduced by using a nematic liquid crystal.

Specific examples of the nematic liquid crystal compound include an azomethine compound, a cyano substituted biphenyl compound, phenyl ester, fluorine substituted phenyl ester, cyclohexane carboxylic phenyl ester, fluorine substituted-cyclohexane carboxylic phenyl ester, cyano substituted-phenyl cyclohexane, fluorine substituted-phenyl cyclohexane, cyano substituted-phenyl pyrimidine, fluorine substituted-phenyl pyrimidine, alkoxy substituted-phenyl pyrimidine, fluorine substituted- and alkoxy substituted-phenyl pyrimidine, phenyl dioxane, a tolan compound, a fluorine substituted-tolan compound, and alkenyl cyclohexyl benzonitrile.

A liquid crystal with negative dielectric anisotropy requires a structure with a large dielectric anisotropy in the minor axis direction of its molecules. Examples of such a liquid crystal include those having the structure disclosed in Gekkan Dispurei (Display Monthly) April 2000, pp. 4-9 and the structure disclosed in Syn Lett., Vol. 4, 1999, pp. 389-396. In particular, from the viewpoint of voltage retention rate, a liquid crystal with negative dielectric anisotropy having a fluorine substituent is preferable. Examples thereof include liquid crystals manufactured by Merck & Co. (MLC-6608, 6609, 6610).

The dielectric anisotropy of the host liquid crystal is preferably as high as possible in the negative direction. A preferable range thereof is 1 to −50, and a more preferable range thereof is −2 to −30.

For the purpose of changing the properties of the host liquid crystal (such as the temperature range of the liquid crystal phase, the dielectric anisotropy, or the refractive anisotropy), the liquid crystal composition of the invention may further include additives that do not have liquid crystal properties. The liquid crystal composition of the invention may further include various additives (such as an ultraviolet absorbing agent, antioxidant or the like).

### Polymer Material

The light modulating material and the liquid crystal layer of the liquid crystal display device of the invention includes both at least one liquid crystal composition, and a polymer material. The principle of changing between the scattered state and the transparent state in the invention is hereinafter explained.

First, the refractive index (n∥) of the liquid crystal molecules in the major axis direction is arranged to be as close as possible to the refractive index (np) of the polymer material. Then, the liquid crystal molecules are made to be vertically aligned when no voltage is applied. In this case, the refractive index difference between the liquid crystal composition and the polymer material is small, and light is easily transmitted without being scattered. In other words, a transparent state is achieved.

The refractive anisotropy (Δn) is defined as shown in the following equation. Namely, the refractive anisotropy is defined as the difference between the refractive index (n∥) of the liquid crystal molecules in the major axis direction and the refractive index (n⊥) of the liquid crystal molecules in the minor axis direction.

Δn=n∥−n⊥

When voltage is applied to a host liquid crystal of which Δn is not 0, since the dielectric anisotropy Δε of the host liquid crystal is negative, the host liquid crystal moves to be horizontally aligned. Thus, light is scattered due to the difference between the refractive index (n⊥) of the host liquid crystal in the minor axis direction and the refractive index (np) of the polymer material. To intensitfy the light scattering, the difference of n⊥ and np is preferably as large as possible. It is hence desirable to use a host liquid crystal with a large value of Δn. The value of Δn of the host liquid crystal is preferably 0.05 or more, and more preferably 0.10 or more.

On the other hand, to obtain a transparent colored state with less scattering of light, the value of Δn of the host liquid crystal is preferably as small as possible. In this case the value of Δn of the host liquid crystal is preferably 0.15 or less, and more preferably 0.10 or less.

Examples of a method for forming a polymer medium layer that contains the liquid crystal composition in a dispersed state and is used in the light modulating material and the liquid crystal display device of the invention include a method including applying a polymer solution containing the dispersed liquid crystal composition on a substrate. Examples of a method for dispersing the liquid crystal composition in a polymer solution include a mechanical stirring process, a heating process, an ultrasonic process, and a combination of any of these.

In the polymer medium layer, the ratio of a mass of the liquid crystal composition dispersed in the polymer medium to a mass of the polymer medium is preferably in a range of 1:10 to 10:1, and more preferably in a range of 1:1 to 8:2.

Preferable examples of the method for forming the polymer medium layer include a method having dissolving the polymer material and the liquid crystal composition and applying the solution on a substrate, and a method having dissolving the liquid crystal composition and the polymer in a common solvent, applying on a substrate, and evaporating the solvent.

The polymer material used in the polymer medium layer is not particularly limited. Examples thereof include siloxane polymers, methyl cellulose, polyvinyl alcohol, polyoxyethylene, polyvinyl butyral, gelatin, and other water-soluble polymers, polyacrylates, polymethacrylates, polyamides, polyesters, polycarbonates, vinyl acetate, polyvinyl butyral, and other polyvinyl alcohol compounds, triacetyl cellulose, and other cellulose compounds, polyurethanes, styrenes, and other water non-soluble polymers.

Preferable examples of the polymer material used in the light modulating material of the invention include siloxane polymers, polyacrylates, and polymethacrylates because they present excellent compatibility with host liquid crystal. Particularly preferable examples thereof include a siloxane polymer, because there is less staining thereof by a dichroic dye and display performance is improved.

When the polymer material of the invention is in a scattered colored state, the polymer material preferably has, at a side chain thereof, a structure including a mesogen having positive dielectric anisotropy, since this makes it easier to cause a phase separation from a host liquid crystal with negative dielectric anisotropy when voltage is applied, and it also increases the diffractive index difference and intensifies the scattering.

Specific examples of the siloxane polymer of the invention are shown below; however, the invention is not limited to these.

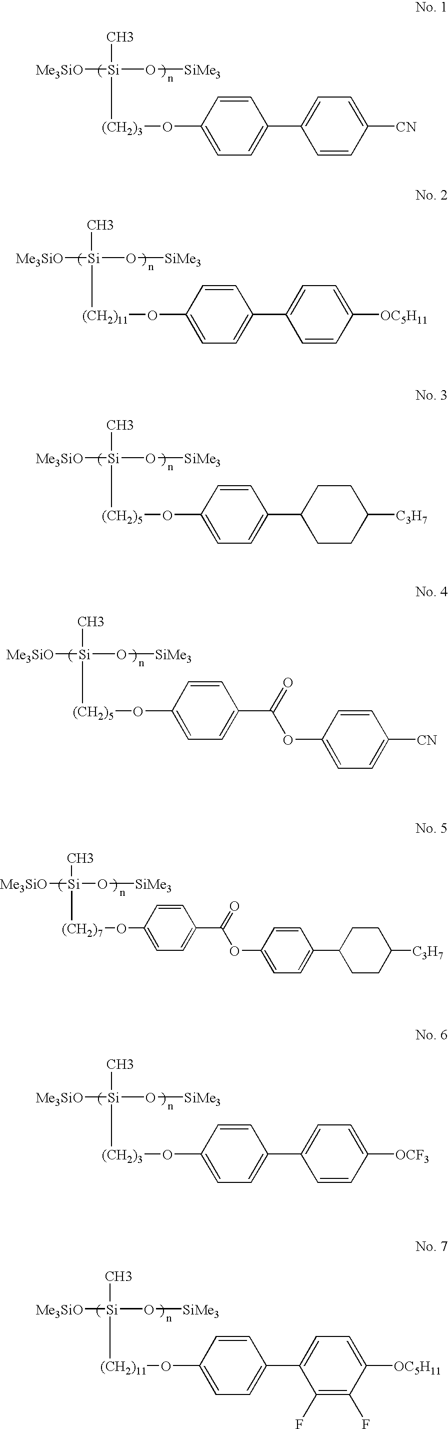

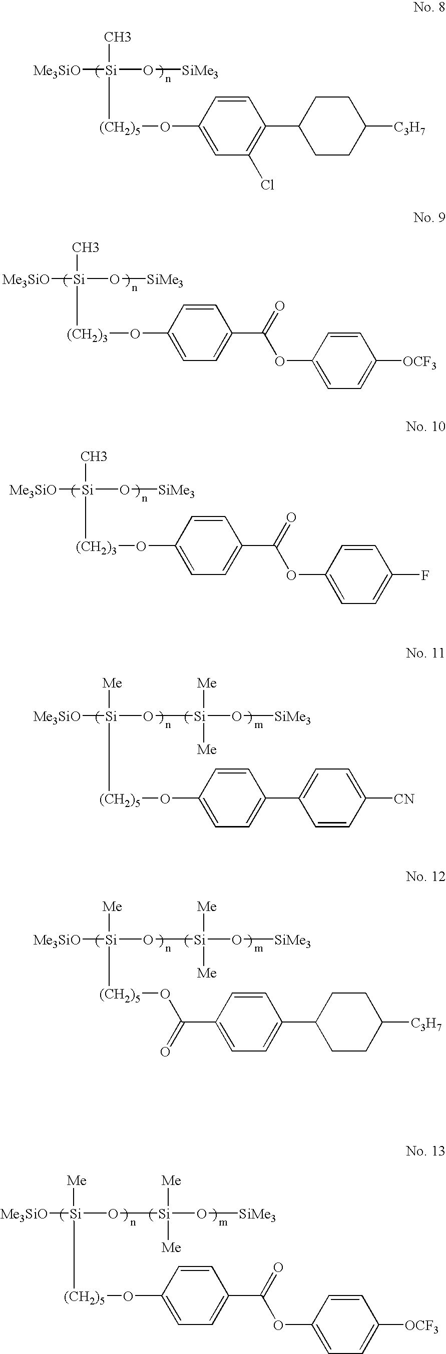

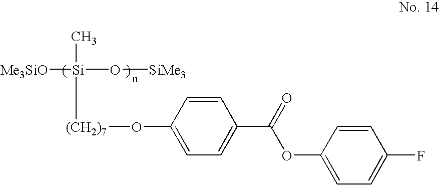

The polymer medium layer may further include a surfactant for the purpose of stabilizing the dispersion of the liquid crystal composition. While the surfactant usable in the invention is not particularly limited, nonionic surfactants are preferable, and examples thereof include sorbitan fatty acid esters, polyoxy ethylene fatty acid esters, polyoxy ethylene alkyl ethers, and fluoroalkyl ethylene oxides.

### Dichroic Dye

The liquid composition of the invention contains a dichroic dye. The dichroic dye is defined to be a compound that is dissolved in a host liquid crystal and that absorbs light. While the absorption maximum and absorption band of the dichroic dye are not particularly specified, it is preferable to have the absorption maximum in the yellow region (Y), magenta region (M), or cyan region (C).

It is also preferable to conduct full color display by using dichroic dye having absorption in green, red, and blue regions.

The dichroic dye used in each of the liquid crystal compositions may be used either singly or in a combination of two or more. When plural dyes are used in a mixed manner, dyes having the same kind of chromophore may be mixed, or dichroic dyes having different chromophores may be mixed, and it is preferable to use a mixture of dichroic dyes having an absorption maximum in Y, M, and C.

Examples of known dichroic dyes include those mentioned by A. V. Ivashchenko in “Dichroic Dyes for Liquid Crystal Display,” CRC, 1994. Methods of full-color display realized by mixing yellow dye, magenta dye, and cyan dye are described in detail in “Color Chemistry” (Sumio Tokita, Maruzen, 1982). Here, the yellow region is a range of 430 to 490 nm, the magenta region is a range of 500 to 580 nm, and the cyan region is a range of 600 to 700 nm.

Next, the chromophore used in the dichroic dye of the invention is described. The chromophore of the dichroic dye is not particularly specified. Examples thereof include an azo dye, an anthraquinone dye, a perylene dye, a melocyanine dye, an azomethine dye, a phthaloperylene dye, an indigo dye, an azulene dye, a dioxazine dye, a polythiophene dye, and a phenoxazine dye. Preferable examples thereof include an azo dye, an anthraquinone dye, and a phenoxazine dye, and particularly preferable examples thereof include an anthraquinone dye and a phenoxazone dye (phenoxazine-3-on).

The scope of the azo dye includes a monoazo dye, a bisazo dye, a trisazo dye, a tetraxisazo dye, and a pentaxiazo dye. Preferable examples thereof include a monoazo dye, a bisazo dye, and a trisazo dye.

Examples of a ring structure included in the azo dye include an aromatic group (a benzene ring, a naphthalene ring, etc.) and a complex ring (such as a quinoline ring, a pyridine ring, a thiazole ring, a benzothiazole ring, an oxazole ring, a benzoxazole ring, an imidazole ring, a benzimidazole ring, a pyrimidine ring, or the like).

A substituent on the anthraquinone dye preferably contains an oxygen atom, a sulfur atom, or a nitrogen atom. Examples thereof include an alkoxy group, an aryloxy group, an alkylthio group, an arylthio group, an alkylamino group, and an arylamino group. While the number of substitutions by the substituent is not specified, di-substitution, tri-substitution, and tetra-substitution are preferable, and di-substitution and tri-substitution are particularly preferable. While the position of substitution by the substituent is not specified, preferable examples thereof include the di-substitution at positions 1 and 4, the di-substitution at positions 1 and 5, the tri-substitution at positions 1, 4 and 5, the tri-substitution at positions 1, 2 and 4, the tri-substitution at positions 1, 2 and 5, the tetra-substitution at positions at 1, 2, 4 and 5, and the tetra-substitution at positions 1, 2, 5 and 6.

The substituent of the phenoxazone dye (phenoxazine-3-on) preferably contains an oxygen atom, a sulfur atom or a nitrogen atom. Examples thereof include an alkoxy group, an aryloxy group, an alkylthio group, an arylthio group, an alkylamino group, and an arylamino group.

The dichroic dye of the invention preferably contains a substituent represented by Formula (1).

-(Het)ⱼ-{(B¹)ₚ-(Q¹)_{q}-(B²)ᵣ}ₙ—C¹ Formula (1):

In Formula (1), Het represents an oxygen atom or a sulfur atom; each of B¹ and B² independently represents an arylene group, a heteroarylene group, or a divalent cyclic aliphatic hydrocarbon group; Q¹ represents a divalent coupler; C¹ represents an alkyl group, a cycloalkyl group, an alkoxy group, a alkoxy carbonyl group, an acyl group, or an acyloxy group; j represents 0 or 1; each of p, q and r independently represents an integer from 0 to 5; n represents an integer from 1 to 3; (p+r)×n is an integer from 3 to 10; when p, q, or r is 2 or more, two or more of B¹, Q¹ and B² may be the same as or different from each other; and when n is 2 or more, two or more of {(B¹)ₚ-(Q¹)_{q}-(B²)ᵣ} may be the same as or different from each other.

Het represents an oxygen atom or a sulfur atom, and preferably represents a sulfur atom.

Each of B¹ and B² independently represents an arylene group, a heteroarylene group, or a divalent cyclic aliphatic hydrocarbon group, and each may have or may not have a substituent.

The arylene group represented by B¹ or B² is preferably an arylene group having 6 to 20 carbon atoms, and is more preferably an arylene group having 6 to 10 carbon atoms. Specific examples of the arylene group include groups having a benzene ring, a naphthalene ring, or an anthracene ring. Preferable examples thereof include groups having a benzene ring or a substituted benzene ring. More preferable examples thereof include a 1,4-phenylene group.

The heteroarylene group represented by B¹ or B² is preferably a heteroarylene group having 1 to 20 carbon atoms, and is more preferably a heteroarylene group having 2 to 9 carbon atoms. Specific examples of the heteroarylene group include groups having a pyridine ring, a quinoline ring, an isoquinoline ring, a pyrimidine ring, a pyrazine ring, a thiophene ring, a furane ring, an oxazole ring, a thiazole ring, an imidazole ring, a pyrazole ring, an oxadiazole ring, a thiadiazole ring, or a triazole ring, and condensed ring heteroarylene group formed by condensation thereof.

The divalent cyclic aliphatic hydrocarbon group represented by B¹ or B² preferably has 3 to 20 carbon atoms, and more preferably has 4 to 10 carbon atoms. Preferable examples of the divalent cyclic aliphatic hydrocarbon group include a cyclohexane diyl group and a cyclopentane diyl group, more preferable examples thereof include a cyclohexane-1,2-diyl group, a cyclohexane-1,3-diyl group, a cyclohexane-1,4-diyl group, and a cyclopentane-1,3-diyl group, and particularly preferable examples thereof include a (E)-cyclohexane-1,4-diyl group.

The divalent arylene group, the heteroarylene group, and the divalent cyclic aliphatic hydrocarbon group represented by B¹ or B² may further have a substituent. Examples of the substituent include the following substituent group V.

### Substituent Group V:

A halogen atom (for example, chlorine, bromine, iodine, fluorine), a mercapto group, a cyano group, a carboxyl group, a phosphoric acid group, a sulfo group, a hydroxy group, a carbamoyl group having 1 to 10 carbon atoms, preferably having 2 to 8 carbon atoms, and more preferably having 2 to 5 carbon atoms (such as a methyl carbamoyl group, an ethyl carbamoyl group, or a morpholino carbonyl), a sulfamoyl group having 0 to 10 carbon atoms, preferably having 2 to 8 carbon atoms, and more preferably having 2 to 5 carbon atoms (such as a methyl sulfamoyl group, an ethyl sulfamoyl group, or a piperidino sulfonyl group), a nitro group, an alkoxy group having 1 to 20 carbon atoms, preferably having 1 to 10 carbon atoms, and more preferably having 1 to 8 carbon atoms (such as a methoxy group, an ethoxy group, a 2-methoxy ethoxy group, or a 2-phenyl ethoxy group), an aryloxy group having 6 to 20 carbon atoms, preferably having 6 to 12 carbon atoms, and more preferably having 6 to 10 carbon atoms (such as a phenoxy group, a p-methyl phenoxy group, a p-chloro phenoxy group, or a naphthoxy group), an acyl group having 1 to 20 carbon atoms, preferably having 2 to 12 carbon atoms, and more preferably having 2 to 8 carbon atoms (such as an acetyl group, a benzoyl group, or a trichloroacetyl group), an acyloxy group having 1 to 20 carbon atoms, preferably having 2 to 12 carbon atoms, and more preferably having 2 to 8 carbon atoms (such as an acetyloxy group or a benzoyloxy group), an acylamino group having 1 to 20 carbon atoms, preferably having 2 to 12 carbon atoms, and more preferably having 2 to 8 carbon atoms (such as an acetylamino group), a sulfonyl group having 1 to 20 carbon atoms, preferably having 1 to 10 carbon atoms, and more preferably having 1 to 8 carbon atoms (such as a methane sulfonyl group, an ethane sulfonyl group, or a benzene sulfonyl group), a sulfinyl group having 1 to 20 carbon atoms, preferably having 1 to 10 carbon atoms, and more preferably having 1 to 8 carbon atoms (such as a methane sulfinyl group, an ethane sulfinyl group, or a benzene sulfinyl group), a substituted or unsubstituted amino group having 1 to 20 carbon atoms, preferably having 1 to 12 carbon atoms, and more preferably having 1 to 8 carbon atoms (such as an amino group, a methyl amino group, a dimethyl amino group, a benzyl amino group, an anilino group, a diphenyl amino group, a 4-methyl phenyl amino group, a 4-ethyl phenyl amino group, a 3-n-propyl phenyl amino group, a 4-n-propyl phenyl amino group, a 3-n-butyl phenyl amino group, a 4-n-butyl phenyl amino group, a 3-n-pentyl phenyl amino group, a 4-n-pentyl phenyl amino group, a 3-trifluoromethyl phenyl amino group, a 4-trifluoromethyl phenyl amino group, a 2-pyridyl amino group, a 3-pyridyl amino group, a 2-thiazolyl amino group, a 2-oxazolyl amino group, a N,N-methyl phenyl amino group, or a N,N-ethyl phenyl amino group), an ammonium group having 0 to 15 carbon atoms, preferably 3 to 10 carbon atoms, and more preferably 3 to 6 carbon atoms (such as a trimethyl ammonium group or a triethyl ammonium group), a hydrazino group having 0 to 15 carbon atoms, preferably having 1 to 10 carbon atoms, and more preferably having 1 to 6 carbon atoms (such as a trimethyl hydrazino group), an ureido group having 1 to 15 carbon atoms, preferably having 1 to 10 carbon atoms, and more preferably having 1 to 6 carbon atoms (such as an ureido group or a N,N-dimethyl ureido group), an imido group having 1 to 15 carbon atoms, preferably having 1 to 10 carbon atoms, and more preferably having 1 to 6 carbon atoms (such as a succine imido group), an alkylthio group having 1 to 20 carbon atoms, preferably having 1 to 12 carbon atoms, and more preferably having 1 to 8 carbon atoms (such as a methylthio group, an ethylthio group, or a propylthiogroup), an arylthio group having 6 to 80 carbon atoms, preferably having 6 to 40 carbon atoms, and more preferably having 6 to 30 carbon atoms (such as a phenylthio group, a p-methyl phenylthio group, a p-chloro phenylthio group, a 2-pyridylthio group, a 1-naphthylthio group, a 2-naphthylthio group, a 4-propyl cyclohexyl-4′-biphenylthio group, a 4-butyl cyclohexyl-4′-biphenylthio group, a 4-pentyl cyclohexyl-4′-biphenylthio group, or a 4-propylphenyl-2-ethynyl-4′-biphenylthio group), a heteroarylthio group having 1 to 80 carbon atoms, preferably having 1 to 40 carbon atoms, and more preferably having 1 to 30 carbon atoms (such as a 2-pyridylthio group, a 3-pyridylthio group, a 4-pyridylthio group, a 2-quinolylthio group, a 2-furylthio group, or a 2-pyrrolylthio group), an alkoxy carbonyl group having 2 to 20 carbon atoms, preferably having 2 to 12 carbon atoms, and more preferably having 2 to 8 carbon atoms (such as a methoxy carbonyl group, an ethoxy carbonyl group, or a 2-benzyloxy carbonyl group), an aryloxy carbonyl group having 6 to 20 carbon atoms, preferably having 6 to 12 carbon atoms, and more preferably having 6 to 10 carbon atoms (such as a phenoxy carbonyl group), an unsubstituted alkyl group having 1 to 18 carbon atoms, preferably having 1 to 10 carbon atoms, and more preferably having 1 to 5 carbon atoms (such as a methyl group, an ethyl group, a propyl group, or a butyl group), a substituted alkyl group having 1 to 18 carbon atoms, preferably having 1 to 10 carbon atoms, and more preferably having 1 to 5 carbon atoms {such as a hydroxy methyl group, a trifluoromethyl group, a benzyl group, a carboxy ethyl group, an ethoxy carbonyl methyl group, an acetyl amino methyl group, and herein the scope of the substituted alkyl group also includes an unsaturated hydrocarbon group having 2 to 18 carbon atoms, preferably 3 to 10 carbon atoms, and more preferably 3 to 5 carbon atoms (such as a vinyl group, an ethynyl group, a 1-cyclohexenyl group, a benzilidine group, or a benzilidene group)}, a substitute or unsubstituted aryl group having 6 to 20 carbon atoms, preferably having 6 to 15 carbon atoms, and more preferably having 6 to 10 carbon atoms (such as a phenyl group, a naphthyl group, a p-carboxy phenyl group, a p-nitrophenyl group, a 3,5-dichlorophenol group, a p-cyanophenyl group, a m-flurophenyl group, a p-tolyl group, a 4-propyl cyclohexyl-4′-biphenyl group, a 4-butyl cyclohexyl-4′-biphenyl group, a 4-pentyl cyclohexyl-4′-biphenyl group, or a 4-propyl phenyl-2-ethynyl-4′-biphenyl group), and a substituted or unsubstituted heteroaryl group having 1 to 20 carbon atoms, preferably having 2 to 10 carbon atoms, and more preferably 4 to 6 carbon atoms (such as a pyridyl group, a 5-methyl pyridyl group, a thienyl, furyl group, a morpholino group, or a tetrahydrofurfuryl group).

The substituents in the substituent group V may also respectively have a structure in which benzene rings or naphthalene rings are condensed. The substituents in the substituent group V may also be further substituted with a substituent(s) listed in the substituent group V.

Preferable examples of the substituents in the substituent group V include an alkyl group, an aryl group, an alkoxy group, an aryloxy group, a halogen atom, an amino group, a substituted amino group, a hydroxy group, an alkylthio group, and an arylthio group. More preferable examples thereof include an alkyl group, an aryl group, and a halogen atom.

Q¹ represents a divalent coupler. Preferable examples of the divalent coupler represented by Q¹ include a coupler formed of an atomic group composed of at least one atom selected from a carbon atom, a nitrogen atom, a sulfur atom and an oxygen atom. More preferable examples of the divalent coupler represented by Q¹ include a divalent coupler that has 0 to 60 carbon atoms and is composed by combining one or more of: an alkylene group preferably having 1 to 20 carbon atoms, and more preferably having 1 to 10 carbon atoms (such as a methylene group, an ethylene group, a propylene group, a butylene group, a pentylene group, or a cyclohexyl-1,4-diyl group), an alkenylene group preferably having 2 to 20 carbon atoms, and more preferably having 2 to 10 carbon atoms (such as an ethenylene group), an alkynylene group preferably having 2 to 20 carbon atoms, and more preferably having 2 to 10 carbon atoms (such as an ethynylene group), an amido group, an ether group, an ester group, a sulfo amido group, an ester sulfonate group, an ureido group, a sulfonyl group, a sulfinyl group, a thioether group, a carbonyl group, a —NR— group (where R represents a hydrogen atom, an alkyl group, or an aryl group, and the alkyl group represented by R preferably has 1 to 20 carbon atoms, and more preferably having 1 to 10 carbon atoms, and the aryl group represented by R preferably has 6 to 14 carbon atoms, and more preferably having 6 to 10 carbon atoms), an azo group, an azoxy group, a complex ring divalent group (preferably having 2 to 20 carbon atoms, and more preferably having 4 to 10 carbon atoms, and examples thereof include a piperazine-1,4-diyl group).

Preferable examples of the divalent coupler represented by Q¹ include an alkylene group, an alkenylene group, an alkynylene group, an ether group, a thioether group, an amido group, an ester group, a carbonyl group, and a group formed of a combination of any of these.

The divalent coupler represented by Q¹ may further has a substituent. Examples of the substituent include those referred in the substituent group V.

C¹ represents an alkyl group, a cycloalkyl group, an alkoxy group, an alkoxy carbonyl group, an acyl group, or an acyloxy group. The scope of the alkyl group, the cycloalkyl group, the alkoxy group, the alkoxy carbonyl group, the acyl group, or the acyloxy group represented by C¹ includes each group having a substituent.

Preferable examples of the groups represented by C¹ include an alkyl group and a cycloalkyl group respectively having 1 to 30 carbon atoms, preferably having 1 to 12 carbon atoms, and more preferably having 1 to 8 carbon atoms (such as a methyl group, an ethyl group, an propyl group, a butyl group, a t-butyl group, an i-butyl group, a s-butyl group, a pentyl group, a t-pentyl group, a hexyl group, a heptyl group, a octyl group, a cyclohexyl group, a 4-methyl cyclohexyl group, a 4-ethyl cyclohexyl group, a 4-propyl cyclohexyl group, a 4-butyl cyclohexyl group, a 4-pentyl cyclohexyl group, a hydroxymethyl group, a trifluoromethyl group, or a benzyl group), an alkoxy group having 1 to 20 carbon atoms, preferably having 1 to 10 carbon atoms, and more preferably having 1 to 8 carbon atoms (such as a methoxy group, an ethoxy group, a 2-methoxy ethoxy group, or a 2-phenyl ethoxy group), an acyloxy group having 1 to 20 carbon atoms, preferably having 2 to 12 carbon atoms, and more preferably having 2 to 8 carbon atoms (such as an acetyloxy group or a benzoyloxy group), an acyl group having 1 to 30 carbon atoms, preferably having 1 to 12 carbon atoms, and more preferably having 1 to 8 carbon atoms (such as an acetyl group, a formyl group group, a pivaloyl group, a 2-chloroacetyl group, a stearoyl group, a benzoyl group, or a p-n-octyl oxy phenyl carbonyl group), and an alkoxy carbonyl group having 2 to 20 carbon atoms, preferably having 2 to 12 carbon atoms, and more preferably having 2 to 8 carbon atoms (such as a methoxy carbonyl group, an ethoxy carbonyl group, or a 2-benzyloxy carbonyl group).

Further preferable examples of the group represented by C¹ include an alkyl group and an alkoxy group, and particularly preferable examples thereof include an ethyl group, a propyl group, a butyl group, a pentyl group, a hexyl group, and a trifluoromethoxy group.

The group represented by C¹ may further have a substituent. Examples of the substituent include those referred in the substituent group V.

Preferable examples of the substituent on the alkyl group represented by C¹ and belonging to the substituent group V include a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxy carbonyl group, and an aryloxy carbonyl group.

Preferable examples of the substituent on the cycloalkyl group represented by C¹ and belonging to the substituent group V include a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxy carbonyl group, an aryloxy carbonyl group, and an alkyl group.

Preferable examples of the substituent on the alkoxy group represented by C¹ and belonging to the substituent group V include a halogen atom (particularly fluorine atom), a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxy carbonyl group, and an aryloxy carbonyl group.

Preferable examples of the substituent on the alkoxy carbonyl group represented by C¹ and belonging to the substituent group V include a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxy carbonyl group, and an aryloxy carbonyl group.

Preferable examples of the substituent on the acyl group represented by C¹ and belonging to the substituent group V include a halogen atom, a cyano group, a hydroxy group, a carbamoyl group, an alkoxy group, an aryloxy group, an acyl group, an acyloxy group, an acylamino group, an alkylthio group, an arylthio group, a heteroarylthio group, an alkoxy carbonyl group, and an aryloxy carbonyl group.

Preferable examples of the substituent on the acyloxy group represented by C¹ and belonging to the substituent group V include a halogen atom, a cyano group, a hydroxy group, a carbamoyl group, an alkoxy group, an aryloxy group, an acyl group, an acyloxy group, an acylamino group, an amino group, an alkylthio group, an arylthio group, a heteroarylthio group, an alkoxy carbonyl group, and an aryloxy carbonyl group.

j represents 0 or 1, and preferably represents 0.

Each of p, q and r independently represent an integer from 0 to 5. n represents an integer from 1 to 3. The total number of groups represented by B¹ and B², that is, (p+r)×n is an integer from 3 to 10, preferably an integer from 3 to 5. When p, q, or r is 2 or more, two or more of B¹, Q¹ and B² may be the same with or different from each other. When n is 2 or more, two or more of {(B¹)ₚ-(Q¹)_{q}-(B²)ᵣ} may be either the same as or different from each other.

Preferable combinations of p, q, r and n are shown below.

(i) p=3, q=0, r=0, n=1

(ii) p=4, q=0, r=0, n=1

(iii) p=5, q=0, r=0, n=1

(iv) p=2, q=0, r=1, n=1

(v) p=2, q=1, r=1, n=1

(vi) p=1, q=1, r=2, n=1

(vii) p=3, q=1, r=1, n=1

(viii) p=2, q=0, r=2, n=1

(ix) p=1, q=1, r=1, n=2

(x) p=2, q=1, r=1, n=2

Particularly preferable combinations are (i) p=3, q=0, r=0, n=1; (iv) p=2, q=0, r=1, n=1; and (v) p=2, q=1, r=1, n=1.

Herein, —{(B¹)ₚ-(Q¹)_{q}-(B²)ᵣ}ₙ—C¹ preferably contains a partial structure that exhibits liquid crystal properties. While the liquid crystal may have any phase, preferable examples of the liquid crystal include a nematic liquid crystal, a smectic liquid crystal, and a discotic liquid crystal, and particularly preferable examples thereof include a nematic liquid crystal.

Specific examples of —{(B¹)ₚ-(Q¹)_{q}-(B²)ᵣ}ₙ—C¹ are shown below; however, the invention is not limited to these examples. In each of the following formulae, the wavy line indicates a coupling position, and the bullet mark indicates a trans position.

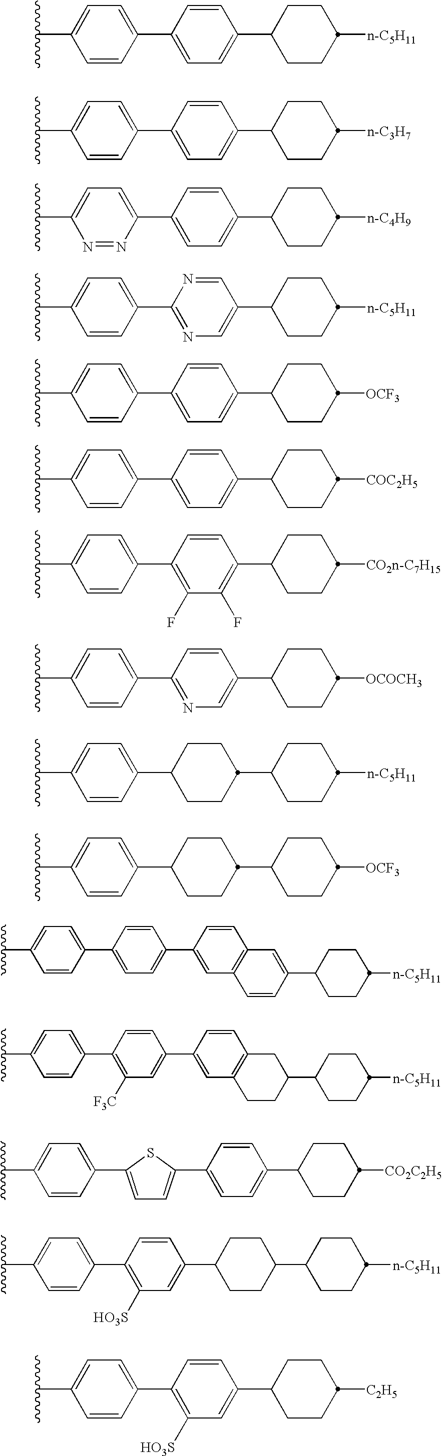

The dichroic dye used in the invention preferably has one or more substituents represented by —{(B¹)ₚ-(Q¹)_{q}-(B²)ᵣ}ₙ—C¹, preferably has 1 to 8 substituents represented by —{(B¹)ₚ-(Q¹)_{q}-(B²)ᵣ}ₙ—C¹, more preferably has 1 to 4 substituents represented by —{(B¹)ₚ-(Q¹)_{q}-(B²)ᵣ}ₙ—C₁, and most preferably has 1 or 2 substituents represented by —{(B¹)ₚ-(Q¹)_{q}-(B²)ᵣ}ₙ—C¹.

Preferable examples of the structure of the substituent represented by Formula (1) include the following configurations.

[1] A structure in which Het represents a sulfur atom, B¹ represents an aryl group or a heteroaryl group, B² represents a cyclohexane-1,4-diyl group, C¹ represents an alkyl group, j=1, p=2, q=0, r=1, and n=1.

[2] A structure in which Het represents a sulfur atom, B¹ represents an aryl group or a heteroaryl group, B² represents a cyclohexane-1,4-diyl group, C¹ represents an alkyl group, j=1, p=1, q=0, r=2, and n=1.

Examples of particularly preferable structures include the following combinations.

[I] A structure represented by Formula (a-1) in which Het represents a sulfur atom, B¹ represents a 1,4-phenylene group, B² represents a trans-cyclohexyl group, C¹ represents an alkyl group (preferably a methyl group, an ethyl group, a propyl group, a butyl group, a pentyl group, or a hexyl group), j=1, p=2, q=0, r=1, and n=1.

[II] A structure represented by Formula (a-2) in which Het represents a sulfur atom, B¹ represents a 1,4-phenylene group, B² represents a trans-cyclohexane- 1,4-diyl group, C¹ represents an alkyl group (preferably a methyl group, an ethyl group, a propyl group, a butyl group, a pentyl group, or a hexyl group), j=1, p=1, q=0, r=2, and n=1.

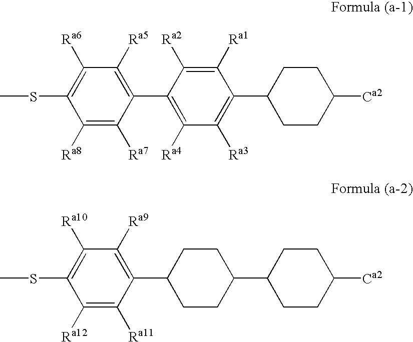

In Formulae (a-1) and (a-2), each of R^{a1} to R^{a12} independently represent a hydrogen atom or a substituent. Examples of the substituent include substituents selected from the substituent group V.

Preferably, each of R^{a1} to R^{a12} independently represent a hydrogen atom, a halogen atom (particularly a fluorine atom), an alkyl group, aryl group, and an alkoxy group. Preferable examples among the alkyl group, the aryl group, and the alkoxy group represented by R^{a1} to R^{a12} are the same as the preferable examples of the alkyl group, the aryl group, and the alkoxy group in the substituent group V.

In Formulae (a-1) and (a-2), each of C^{a1} and C^{a2} independently represent an alkyl group, preferably represent an alkyl group having 1 to 20 carbon atoms, and more preferably represent 1 to 10 carbon atoms. Particularly preferable examples thereof include a methyl group, an ethyl group, a propyl group, a butyl group, a pentyl group, a hexyl group, a heptyl group, an octyl group, and a nonyl group.

Particularly preferable examples of the substituent represented by Formula (1) include long-chain alkyl groups represented by Formulae (a-1) or (a-2) in which C^{a1} or C^{a2} has 3 to 10 carbon atoms, since the solubility in liquid crystal is improved and the absorption of light in a colored state is increased so as to be advantageous for a light modulating material. Although the reason for this effect is not clear, it is assumed that phase solubility with the host liquid crystal is enhanced by having such a configuration.

The anthraquinone dye included as a chromophore in the dichroic dye of the invention is preferably a compound represented by the following Formula (2). The phenoxazone dye included as a chromophore in the dichroic dye of the invention is preferably a compound represented by the following Formula (3).

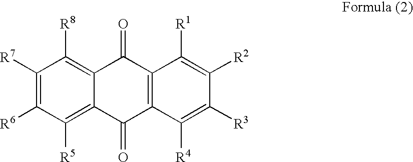

In Formula (2), at least one of R¹, R², R³, R⁴, R⁵, R⁶, R⁷, and R⁸ is -(Het)ⱼ-{(B¹)ₚ-(Q¹)_{q}-(B²)ᵣ}ₙ—C¹, and each of others independently represents a hydrogen atom or a substituent.

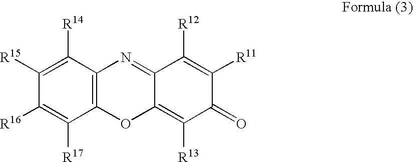

In Formula (3), at least one of R¹¹, R¹², R¹³, R¹⁴, R¹⁵, R¹⁶, and R¹⁷ is -(Het)ⱼ-{(B¹)ₚ-(Q¹)_{q}-(B²)ᵣ}ₙ—C¹, and each of others independently represents a hydrogen atom or a substituent.

Herein, each of the scopes represented by Het, B¹, B², Q¹, j, p, q, r, n, or C¹ is the same as the scope of Het, B¹, B², Q¹, j, p, q, r, n, or C¹ in Formula (1) respectively.

Examples of the substituent represented by R¹, R², R³, R⁴, R⁵, R⁶, R⁷, or R⁸ in Formula (2) include those referred in the substituent group V. Preferable examples thereof include an arylthio group having 6 to 80 carbon atoms, preferably having 6 to 40 carbon atoms, and more preferably having 6 to 30 carbon atoms (such as a phenylthio group, a p-methyl phenylthio group, a p-chloro phenylthio group, a 4-methyl phenylthio group, a 4-ethyl phenylthio group, a 4-n-propyl phenylthio group, a 2-n-butyl phenylthio group, a 3-n-butyl phenylthio group, a 4-n-butyl phenylthio group, a 2-t-butyl phenylthio group, a 3-t-butyl phenylthio group, a 4-t-butyl phenylthio group, a 3-n-pentyl phenylthio group, a 4-n-pentyl phenylthio group, a 4-amyl pentyl phenylthio group, a 4-hexyl phenylthio group, a 4-heptyl phenylthio group, a 4-octyl phenylthio group, a 4-trifluoromethyl phenylthio group, a 3-trifluoromethyl phenylthio group, a 2-pyridylthio group, a 1-naphthylthio group, a 2-naphthylthio group, a 4-propylcyclohexyl-4′-biphenylthio group, a 4-butylcyclohexyl-4′-biphenylthio group, a 4-pentylcyclohexyl-4′-biphenylthio group, or a 4-propylphenyl-2-ethynyl-4′-biphenylthio group), a heteroarylthio group having 1 to 80 carbon atoms, preferably having 1 to 40 carbon atoms, and more preferably having 1 to 30 carbon atoms (such as a 2-pyridylthio, 3-pyridylthio group, a 4-pyridylthio group, a 2-quinolylthio group, a 2-furylthio group, or a 2-pyrrolylthio), a substituted or unsubstituted alkylthio group (such as a methylthio group, an ethylthio group, a butylthio group, or a phenethylthio group), a substituted or unsubstituted amino group (such as an amino group, a methyl amino group, a dimethyl amino group, a benzyl amino group, an anilino group, a diphenyl amino group, a 4-methyl phenyl amino group, a 4-ethyl phenyl amino group, a 3-n-propyl phenyl amino group, a 4-n-propyl phenyl amino group, a 3-n-butyl phenyl amino group, a 4-n-butyl phenyl amino group, a 3-n-pentyl phenyl amino group, a 4-n-pentyl phenyl amino group, a 3-trifluoromethyl phenyl amino group, a 4-trifluoromethyl phenyl amino group, a 2-pyridyl amino group, a 3-pyridyl amino group, a 2-thiazolyl amino group, a 2-oxazolyl amino group, a N,N-methyl phenyl amino group, or a N,N-ethyl phenyl amino), a halogen atom (such as a fluorine atom or a chlorine atom), a substituted or unsubstituted alkyl group (such as a methyl group or a trifluoromethyl group), a substituted or unsubstituted alkoxy group (such as a methoxy group or a trifluoromethoxy group), a substituted or unsubstituted aryl group (such as a phenyl group), a substituted or unsubstituted heteroaryl group (such as a 2-pyridyl group), a substituted or unsubstituted aryloxy group (such as a phenoxy group), and a substituted or unsubstituted heteroaryloxy group (such as a 3-thienyloxy group).

Preferable examples of R¹, R², R³, R⁴, R⁵, R⁶, R⁷, and R⁸ include a hydrogen atom, a fluorine atom, a chlorine atom, a substituted or unsubstituted arylthio group, an alkylthio group, an amino group, an alkylamino group, an arylamino group, an alkyl group, an aryl group, an alkoxy group, or an aryloxy group, and particularly preferable examples thereof include a hydrogen atom, a fluorine atom, a substituted or unsubstituted arylthio group, an alkylthio group, an amino group, an alkylamino group, or an arylamino group.

Further preferable examples of the compound represented by Formula (2) include those in which at least one of R¹, R⁴, R⁵, and R⁸ in Formula (2) is -(Het)ⱼ-{(B¹)ₚ-(Q¹)_{q}-(B²)ᵣ}ₙ—C¹.

Examples of the substituent represented by R¹¹, R¹², R¹³, R¹⁴, R¹⁵, R¹⁶, and R¹⁷ in Formula (3) include a halogen atom, an alkyl group, an aryl group, an alkylthio group, an arylthio group, a hetero ring thio group, a hydroxyl group, an alkoxy group, an aryloxy group, a carbamoyl group, an acyl group, an aryloxy carbonyl group, an alkoxy carbonyl group, and an amido group, and particularly preferable examples thereof include a hydrogen atom, a halogen atom, an alkyl group, an arylthio group, and an amido group.

Preferable examples of R¹⁶ include an amino group (the scope thereof includes an alkylamino group and an arylamino group), a hydroxyl group, a mercapto group, an alkylthio group, an arylthio group, an alkoxy group, or an aryloxy group, and particularly preferable examples thereof include an amino group.

Specific examples of the dichroic dye usable in the invention are shown below; however, the invention is not limited to these. In each of the following formulae, the bullet mark indicates a trans position.

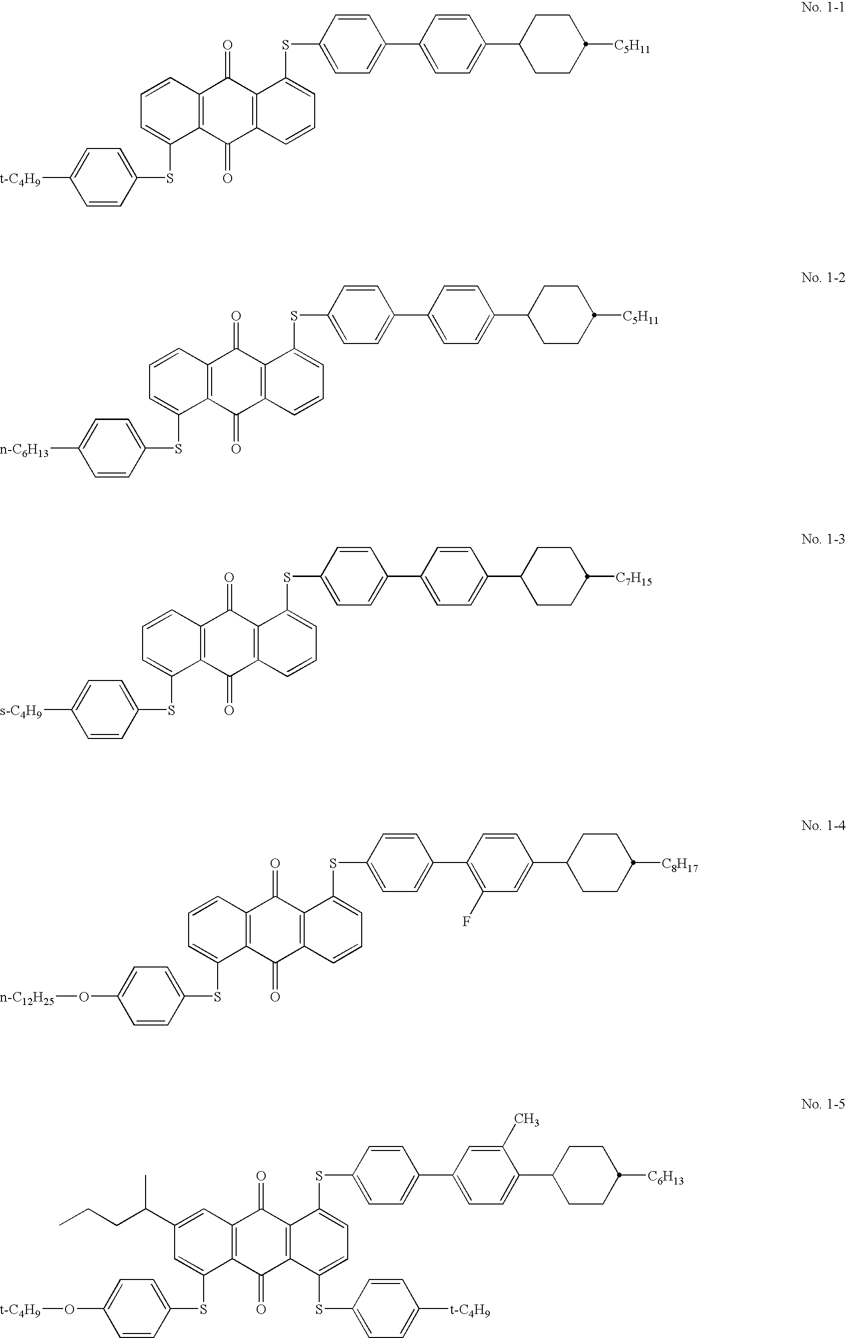

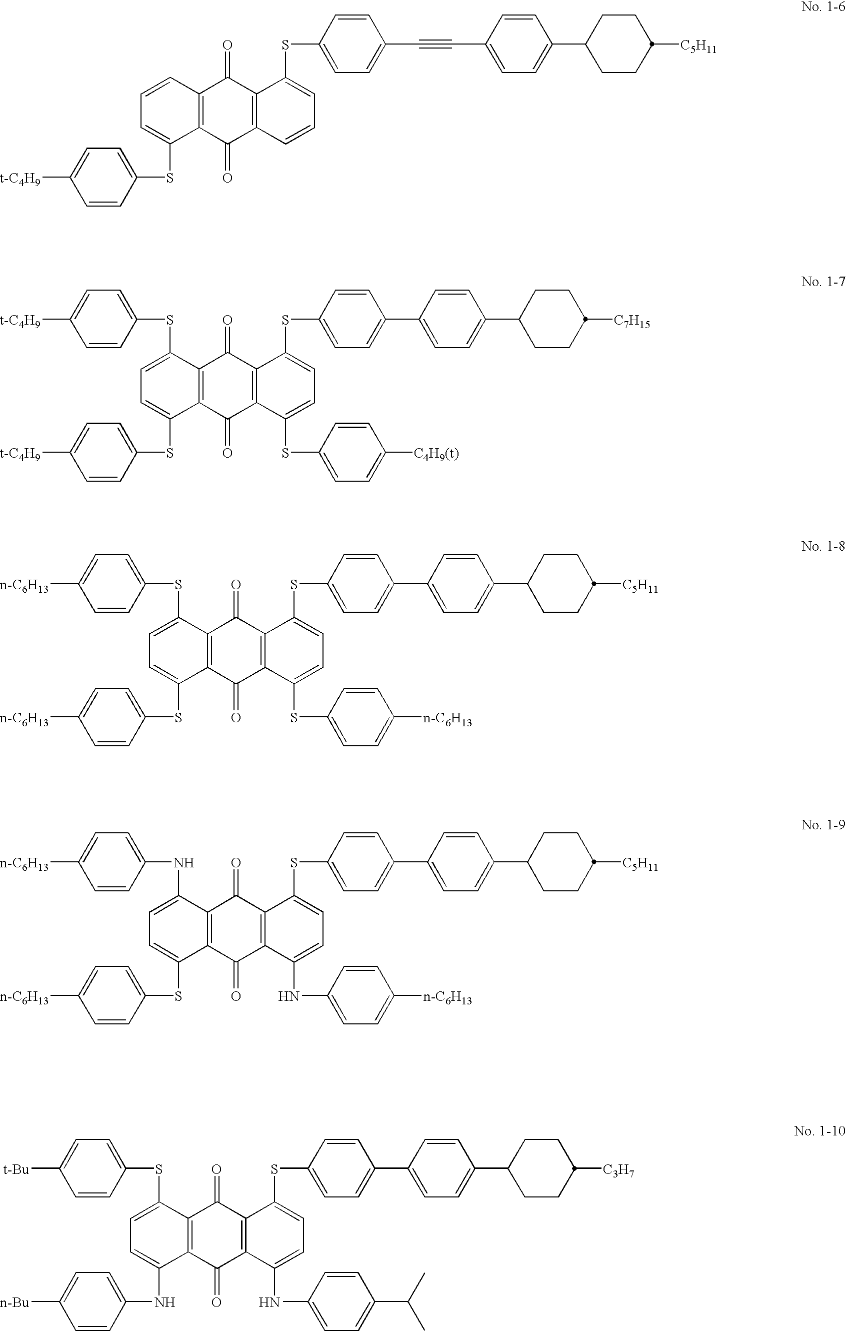

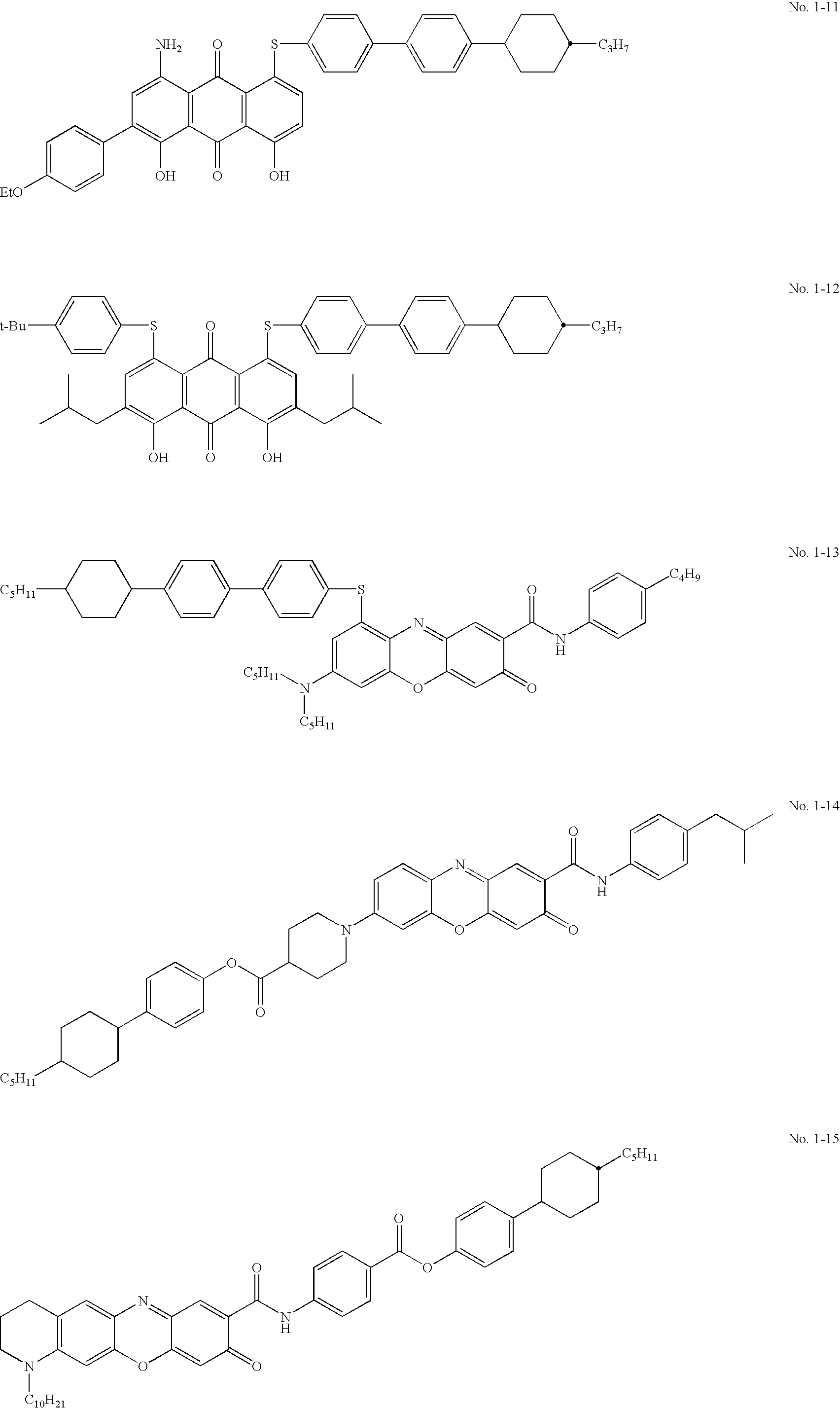

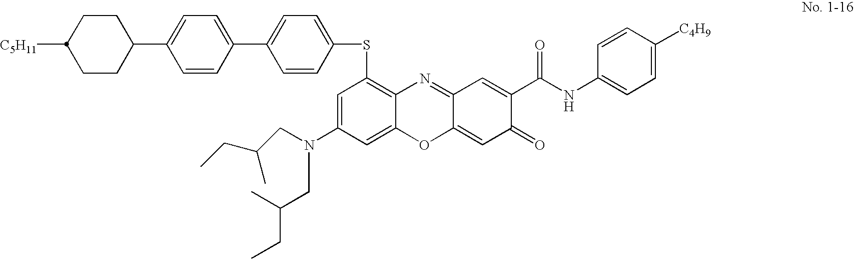

Specific examples of the azo dichroic dye usable in the invention are shown below; however, the invention is not limited to these. In each of the following formulae, the bullet mark indicates a trans position.

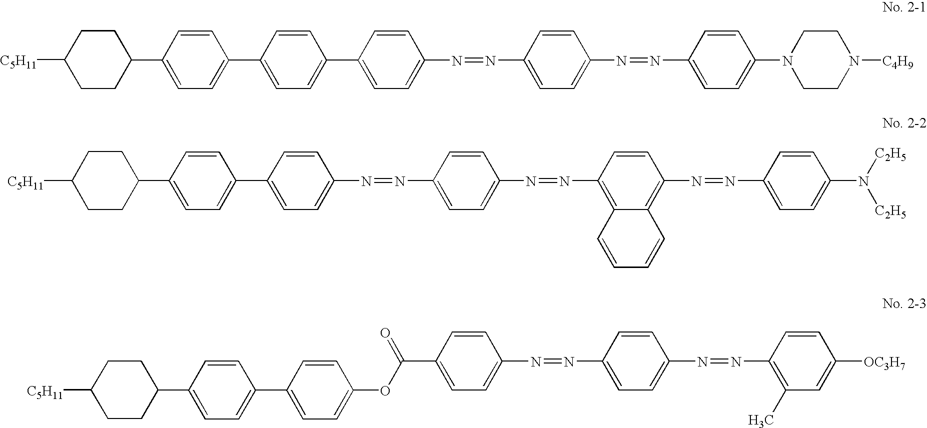

Specific examples of the dioxazine dichroic dye and the melocyanine dichroic dye usable in the invention are shown below; however, the invention is not limited to these.

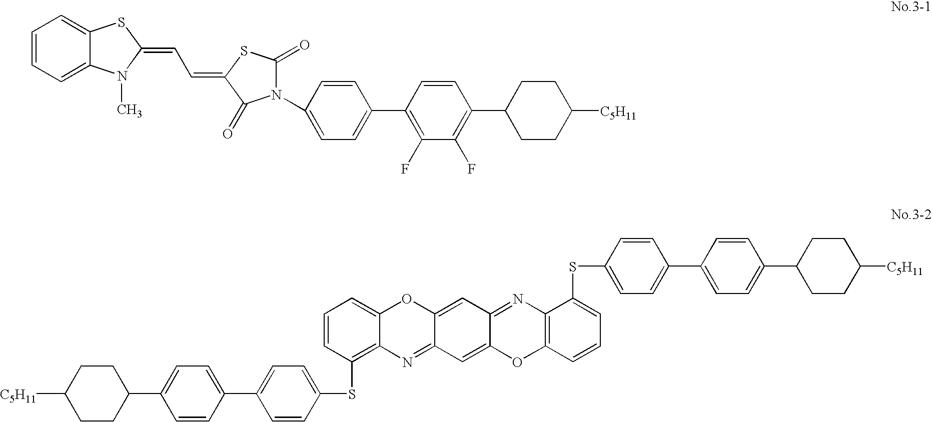

The dichroic dye having the substituent represented by Formula (1) can be synthesized by combining known methods. For example, it can be synthesized by the method disclosed in Japanese Patent Application Laid-Open (JP-A) No. 2003-192664.

While the relative content of the host liquid crystal and the dichroic dye in the light modulating material of the invention is not particularly specified, the content of dichroic dye is preferably in a range of 0.1 to 15 mass %, is more preferably in a range of 0.5 to 10 mass %, and is most preferably in a range of 1 to 8 mass %, relative to the content of the host liquid crystal.

The relative content of the host liquid crystal and the dichroic dye for providing a desired optical concentration of a liquid crystal cell is preferably determined by preparing a liquid crystal composition containing both the host liquid crystal and the dichroic dye, and measuring the absorption spectrum of a liquid crystal cell filled with the liquid crystal composition.

With regard to the light modulating performance of the light modulating material of the invention, the ratio of the transmissivity of light in the colored state to the transmissivity of light in the transparent state (transparent state/colored state) is preferably in a range of 3 to 1,000, is more preferably in a range of 4 to 1,000, and is most preferably in a range of 5 to 1,000.

The thickness of liquid crystal layer of the light modulating material of the invention is preferably in a range of 1 to 30 μm, is more preferably in a range of 2 to 20 μm, and is most preferably in a range of 5 to 15 μm.

Preferably, the light modulating material has a particularly high content of dichroic dye in order to improve its light modulating performance.

The light modulating material of the invention may include plural dichroic dyes mixed in one liquid crystal layer. The color to be presented thereby is not specified.

Separate liquid crystal layers presenting various colors may be laminated. Liquid crystal layers (liquid crystal parts) presenting various colors may be arranged in parallel.

### Configuration of Light Modulating Material]

Constituent Members

Electrode Substrate

Usually, an electrode substrate can be composed by forming an electrode layer on a substrate formed of glass or plastic (polymer). The electrode substrate is preferably a plastic substrate. Examples of the material of the plastic substrate include an acrylic resin, a polycarbonate resin, an epoxy resin, polyether sulfone (PES), and polyethylene naphthalate (PEN). Examples of the substrate further include those mentioned in pages 218 to 231 of “Liquid Crystal Device Handbook” (ed. by Committee No. 142 of the Japan Society for the Promotion of Science, Nikkan Kogyo Shimbun-sha, 1989).

In the light modulating material, both electrode layers formed on the substrate are transparent electrodes. In the liquid crystal display device, at least one of the electrode layers formed on the substrate is a transparent, and preferably one electrode layer is a transparent electrode.

The transparent electrode can be formed of indium oxide, ITO (indium tin oxide), tin oxide or the like. Examples of the transparent electrode include those mentioned in pages 232 to 239 of “Liquid Crystal Device Handbook” (ed. by Committee No. 142 of the Japan Society for the Promotion of Science, Nikkan Kogyo Shimbun-sha, 1989).

Spacer

Examples of the configuration of the light modulating material of the invention include a structure in which a pair of substrates are disposed so as to face each other through a spacer at an interval of 1 to 50 μm, and a liquid crystal composition is disposed in the space formed between the substrates. Examples of the spacer include those described in pages 257 to 262 of “Liquid Crystal Device Handbook” (ed. by Committee No. 142 of the Japan Society for the Promotion of Science, Nikkan Kogyo Shimbun-sha, 1989). The light modulating material of the invention can be disposed in the space between the substrates by being applied or printed on the substrate.

The thickness of the liquid crystal layer, that is, the interval between the substrates formed by the spacer in the light modulating material of the invention is preferably in a range of 1 to 30 μm, and is more preferably in a range of 2 to 20 μm. If the thickness of the liquid crystal layer is larger than 30 μm, the transmissivity of the liquid crystal layer in a transparent state may tend to decline, while if it is smaller than 1 μm, electrical conduction due to partial defects may cause unevenness in the display.

Layer Subjected to Alignment Treatment

In order to vertically align the liquid crystal composition when no voltage is applied, it is preferable to form a layer that is subjected to a treatment for providing alignment, on the substrate, at a surface thereof which contacts with the liquid crystal. Examples of the alignment treatment include a method of applying a quaternary ammonium salt, a method of applying polyimide and rubbing, a method of depositing SiOx by evaporation from an oblique direction, and a method of irradiating light by making use of photoisomerization.

It is particularly preferable that the alignment treatment includes forming a vertically aligned layer. More specifically, methods of aligning by holding the liquid crystal layer between a pair of vertically aligned layers are preferable. Examples of the alignment layer are described in pages 240 to 256 of “Liquid Crystal Device Handbook” (ed. by Committee No. 142 of the Japan Society for the Promotion of Science, Nikkan Kogyo Shimbun-sha, 1989). Preferable examples of the material for forming the alignment layer include a polyimide, a silane coupling agent, a polyvinyl alcohol, and gelatin, and more preferable examples thereof include a polyimide and a silane coupling agent from the viewpoints of alignment capabilities, durability, insulation, and cost.

To enhance the alignment force in a vertical direction, the alignment layer is preferably made to be hydrophobic, and it is desirable for this purpose to enhance the hydrophobic degree of a polyimide side chain substituent or a substituent of a silane coupling agent. Specific examples of materials preferable for this purpose include a polyimide having a long-chain alkyl group, a long-chain aryl group or the like, and a silane coupling agent having a long-chain alkyl group, a long-chain aryl group or the like.

Preferable examples of providing the alignment layer include a method of applying the film forming material and firing. If a silane coupling agent is used, preferable examples of providing the alignment layer further include a method of immersing the substrate in an alcohol solution containing the silane coupling agent to cause a reaction between the surface of the substrate and the silane coupling agent.

Other Members

Examples of members other than those described above include a barrier film, an ultraviolet absorbing film, an anti-reflection film, a hard coat layer, a stainproof film, an organic interlayer insulation film, a metal reflection plate, a phase difference plate, and an alignment layer. These may be used either singly or in combination of two or more.

In the invention, a barrier layer is preferably disposed for blocking transmission of water and/or oxygen.

Examples of the barrier layer include a barrier layer formed of an organic polymer system, a barrier layer formed of an inorganic system and a barrier layer formed of an organic-inorganic complex system. Examples of a material for forming the organic polymer system include ethylene-vinyl alcohol (EVOH), polyvinyl alcohol (PVA/PVOH), nylon MXD6 (N-MXD), and nano-composite system nylon. Examples of a material for forming the inorganic system include silica, alumina, and other two-dimensional systems. Further details are explained, for example, in “Development of high barrier material, and measuring and evaluating method of film forming technology and barrier performance” (Society of Engineering Information, 2004).

In the light modulating material of the invention, the barrier film is preferably disposed on the support body, at a side which does not have the transparent electrode, from the viewpoint of ease of manufacturing. The barrier may be disposed either at both opposite support bodies, or at one side only.

In the invention, it is preferable to dispose an ultraviolet absorption layer in order to prevent deterioration of the liquid crystal due to ultraviolet rays.

The ultraviolet absorption layer preferably includes antioxidants such as 2,2-thiobis (4-methyl-6-t-butyl phenol), 2,6-di-t-butyl phenol or the like, and/or ultraviolet absorbing agents such as 2-(3-t-butyl-5-methyl-2-hydroxy phenyl)-5-chlorobenzotriazole, alkoxy benzophenone or the like.

In the light modulating material of the invention, the ultraviolet absorption layer is preferably disposed on the support body at a side which does not have the transparent electrode from the viewpoint of ease of manufacture. The ultrasonic absorption layer may be disposed either at both opposite support bodies, or at one side only; however, it is preferably disposed at least in the support body formed on the light incident side, in order to perform the functions of an ultraviolet absorption layer.

The anti-reflection film can be formed by using an inorganic material or an organic material. The configuration of the anti-reflection film may be either a single layer or multiple layers. Alternatively, the configuration of the anti-reflection film may be a multilayer structure composed of at least one film formed of an inorganic material and at least one film formed of an organic material. The anti-reflection film may be provided at either one side or both sides of the light modulating material. When anti-reflection films are provided at both sides of the light modulating material, the configurations of the two anti-reflection films may be either the same as or different from each other. For example, one anti-reflection film may be a multilayer structure, while the other anti-reflection film may be simplified to a single-layer structure. The anti-reflection film may be directly provided on the transparent electrode or the support body.

Examples of inorganic materials that may be used in the anti-reflection film include SiO₂, SiO ZrO₂, TiO₂, TiO, Ti₂O₃, Ti₂O₅, Al₂O₃, Ta₂O₅, CeO₂, MgO, Y₂O₃, SnO₂, MgF₂, and WO₃. These may be used singly or in combinations of two or more. In particular, when the support body is a lens made of plastic, SiO₂, ZrO₂, TiO₂, and Ta₂O₅ are preferable among these because they can be applied using vacuum deposition at a low temperature.

Examples of the configuration of the multilayer film formed of the inorganic material include a laminate structure formed by alternately providing from the support body side a high refractive index material layer and a low refractive index material layer, in the sequence of a ZrO₂ layer having an optical wavelength of a quarter wavelength (λ/4) and an outermost SiO₂ surface layer having an optical wavelength of a quarter wavelength (λ/4), giving a total optical film thickness of a half wavelength (λ/2). Herein, the wavelength (λ) is the design wavelength, and is usually 520 nm. The outermost layer in the configuration of the multilayer film is preferably a SiO₂ layer since it has a low refractive index and is capable of providing mechanical strength to the anti-reflection film.

When the anti-reflection film is formed with an inorganic material, examples of a method of forming thereof include an ion plating method, a sputtering method, a CVD method, and a deposition method by a chemical reaction in a saturated solution.

Examples of organic materials that may be used in the anti-reflection film include FFP (tetrafluoroethylene-hexafluoropropylene copolymer), PTFE (polytetrafluoroethylene), and ETFE (ethylene-tetraflooroethylene copolymer), which may be selected taking into consideration the refractive index of materials used for forming the support body, such as a lens material or hard coat layer (if provided on the support body). In addition to the vacuum deposition method, examples of the film forming method further include a spin coat method, a dip coat method, and other coating methods advantageous for mass production.

Examples of materials that may be used for the hard coat layer include conventionally-known acrylic resins and epoxy resins which are ultraviolet curable or electron curable.

Examples of materials that may be used for the stainproof film include water-repellent and oil-repellent materials such as organic polymers containing fluorine.

The light modulating material of the invention may also be applied to a reflective display device. That is, the light modulating material of the invention may be used as a reflective display device by providing a reflective layer on one substrate in a configuration in which the liquid crystal composition of the invention is placed between a pair of electrodes, at least one of which is a transparent electrode. A white scattering layer is preferable as the reflective layer, and examples thereof include a white scattering layer having titanium oxide white pigment dispersed in a polymer binder.

The light modulating material of the invention can provide a high level of light modulating performance, and can lend itself well to various applications such as light modulating, security applications, vehicle-mounted applications, interiors, advertisements, and information display boards.

### EXAMPLES

Hereinafter, the invention is more specifically described by referring to examples. In the following examples, the materials, reagents, mass quantities and ratios thereof, and modes of operation may be arbitrarily changed as long as the essential configuration of the invention is not lost thereby. Hence, the invention is not limited by these examples.

### Example 1

### Preparation of Light Modulating Material

### 1. Preparation of Dichroic Dye and Liquid Crystal

Dichroic dyes (1-2) and (1-8) were synthesized according to the method disclosed in JP-A No. 2003-192664. A dichroic dye (1-13) was synthesized according to the method disclosed in JP-A No. 2005-120334. A yellow compound Y-1, a magenta compound M-1, and a cyan compound C-1 were synthesized according to the method disclosed in Jpn. J. Appl. Phys., Vol. 37, p. 3422 (1998).

A host liquid crystal ZLI-2806 (a nematic liquid crystal) was purchased from Merck & Co. In addition, polymer materials No. 4 and No. 9 of the exemplary compounds were synthesized according to the following schemes.

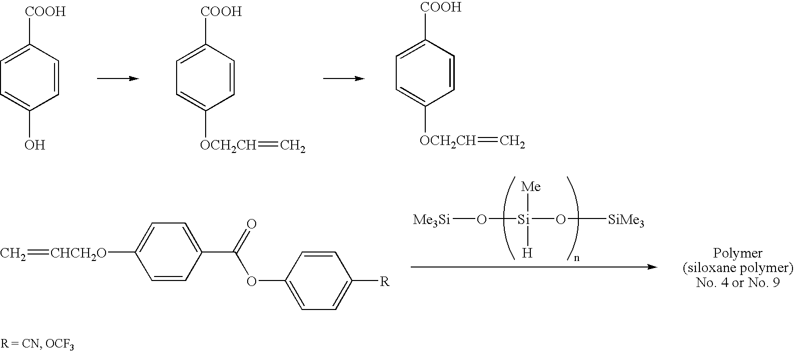

### 2. Preparation of Light Modulating Material Using a Liquid Crystal composition Containing Dichroic Dye

A film having vertically aligned polyimide (manufactured by Nissan Chemical) was provided on a glass substrate having ITO, that is, on a transparent substrate, by spin coating and firing.

In 1.0 g of the host liquid crystal (trade name: ZLI-2806, described above: Δn=0.043), the dichroic dye or one of yellow compound Y-1, magenta compound M-1, and cyan compound C-1 shown in the following Table 1, and the polymer materials were mixed in the combinations shown in the following Table 2, and the mixtures were heated and dissolved, and let stand overnight at room temperature. Acetone was used as an auxiliary solvent.

The content of each dichroic dye was adjusted so that the transmissivity might be 20% when the liquid crystal composition was injected in a liquid crystal evaluation cell having a capacity of 8 μm. The amount of each of the polymer materials was adjusted so that the content might be 5 mass % in the host liquid crystal.

In each of the thus obtained liquid crystal compositions, a slight amount of 16 μm spherical spacer (manufactured by Sekisui Chemical) was mixed, and the glass substrate with ITO was held so that the alignment film side might contact with the liquid crystal layer, and was shielded by photocurable sealing agent (manufactured by Sekisui Chemical).

TABLE 1

| Dichroic dye No. | Remarks |
|---|---|
| 1-8 | Magenta dye |
| 1-13 | Cyan dye |
| 1-2 | Yellow dye |

### 3. Evaluation

Each of the thus obtained light modulating materials of the invention was transparent when no voltage was applied. When a voltage (80 V, 60 Hz) was applied by using a signal generator (manufactured by Techtronics Ltd.), the liquid crystal layer was in a colored scattered state. The UV/vis absorption spectrum in the scattered colored state and the transparent state at maximum absorption wavelength of each of the dichroic dyes were measured using UV2400 (trade name, manufactured by Shimadzu Corporation), and the transmissivities of the light modulating materials in the scattered colored state and the transparent state were measured. The ratios of transmissivity in the scattered colored state to the transparent state (T (transparent)/T (colored)) are shown in Table 2.

As shown in Table 2, it is confirmed that the light modulating material of the invention has a light modulating function capable of electrically controlling the light transmissivity. It is also confirmed that a transparent state of high transmissivity can be achieved by the light modulating material of the invention when no voltage is applied.

TABLE 2

| Sample | Dichroic | Polymer | Ratio of | Initial | |
|---|---|---|---|---|---|
| name | dye No. | material | transmissivity | transmissivity (%) | Remarks |
| A | 1-8 | No. 4 | 8.2 | 80 | Invention |
| B | 1-8 | No. 9 | 8.5 | 80 | Invention |
| C | 1-13 | No. 4 | 8.0 | 82 | Invention |
| D | 1-2 | No. 4 | 8.0 | 82 | Invention |
| E | 1-8 | None | 2.7 | 85 | Comparative |
| | | | | | example |
| F | 1-13 | None | 3.0 | 83 | Comparative |
| | | | | | example |
| G | 1-2 | None | 2.4 | 85 | Comparative |
| | | | | | example |
| H | Y-1 | No. 4 | 6.4 | 75 | Invention |
| I | M-1 | No. 4 | 7.0 | 78 | Invention |
| J | C-1 | No. 4 | 6.8 | 74 | Invention |

Yellow compound Y-1

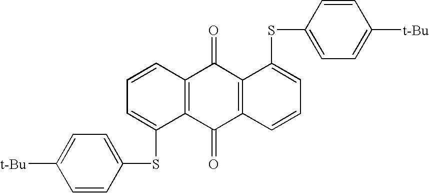

Magenta compound M-1

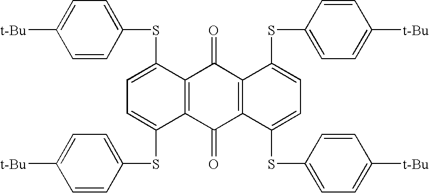

Cyan compound C-1

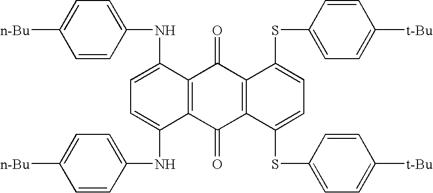

### Example 2

### Preparation of Light Modulating Material

### 1. Preparation of Plastic Substrate

An undercoat layer and a back layer were formed on PEN (trade name: Q65A, manufactured by Dupont-Teijin) in the same manner as in preparation of sample 110 in example 1 in JP-A No. 2000-105445. That is, 100 parts by weight of polyethylene-2,6-naphthalate polymer, and 2 parts by weight of Tinuvin P.326 (trade name, manufactured by Ciba-Geigy) as ultraviolet absorbent were dried, and dissolved at 300° C., extruded from a T-type die, and vertically drawn by 3.3 times at 140° C., and successively drawn laterally by 3.3 times at 130° C., and thermally fixed for 6 seconds at 250° C., and a plastic substrate (PEN) of the invention of 90 μm in thickness was obtained.

### 2. Preparation of Transparent Electrode Layer

On one side of the plastic substrate obtained above, conductive indium tin oxide (ITO) was applied, and a uniform thin film of 200 nm in thickness was laminated. The surface resistance was about 20 Ω/cm², and light transmissivity (500 nm) was 85%. On the ITO surface, an SiO₂ thin film (100 nm) was formed as an anti-reflection film by sputtering. The light transmissivity (500 nm) was 90%.

### 3. Preparation of Liquid Crystal

Using the support body, an SiO₂ layer of 100 nm in thickness was disposed by vapor deposition on the ITO as an alignment layer; octadecyl trimethoxy silane was used as a silane coupling agent, and the substrate was dissolved in its alcohol solution, and a vertically aligned layer was formed. Apart from the above points, the light modulating material in Example 2 of the invention was prepared in the same manner as in Example 1.

### 4. Forming of Barrier Layer and Ultraviolet Absorption Layer

A barrier layer and an ultraviolet absorption layer were further formed on the obtained light modulating material.

Forming of Barrier Layer: Preparation of Organic-Inorganic Hybrid Layer

Ethylene-vinyl alcohol copolymer (trade name: SOANOL D2908, manufactured by The Nippon Synthetic Chemical Industry Co., Ltd.), 8 g, was dissolved in a mixed solvent of 118.8 g of 1-propanol and 73.2 g of water at 80° C. In 10.72 g of this solution, 2.4 ml of 2N hydrochloric acid was added and the solution was stirred. While this solution was stirred, 1 g of tetraethoxy silane was delivered by drops, and the solution was continuously stirred for 30 minutes. The obtained application solution was applied on the support body of the light modulating material by wire bar. It was dried for 5 minutes at 120° C., and an organic-inorganic hybrid layer of about 1 μm in thickness was formed on the light modulating material.

Forming of Ultraviolet Absorption Film

A mixture of 42 g of water, 40 g of silanol denatured polyvinyl alcohol (trade name: R2105, manufactured by Kuraray), and 13.5 g of capsule solution for ultraviolet filtering was prepared, and mixed with 17 g of aqueous solution of 2-(3-t-butyl-5-methyl-2-hydroxy phenyl)-5-chlorobenztriazole of 50 mass %, 65 g of colloidal silica dispersion liquid of 20 mass % (trade name: Snowtechs O, manufactured by Nissan Chemical), 2.5 g of polyoxy ethylene alkyl ether phosphoric ester (trade name: Neoscore CM57, manufactured by TOHO Chemical Industry), and 2.5 g of polyethylene glycol dodecyl ether (trade name: Emulgen 109P, manufactured by Kao), to obtain a coating solution for ultraviolet filtering.

The obtained coating solution was applied on the barrier layer of the light modulating material using a wire bar. By drying for 5 minutes at 120° C., an ultraviolet absorbing layer with a film thickness of about 1 μm was formed on the light modulating material.

### Evaluation of Display Performance

The light modulating material of Example 2 of the invention was evaluated in the same way as in Example 1. Results are shown in Table 3. In Table 3, the dye concentration shows the weight (weight %) in relation to the total mass of the whole liquid crystal composition for composing the liquid crystal layer, and the content of the polymer material is indicated by the weight (weight %) relative to the host liquid crystal.

TABLE 3

| | | | Polymer material | | | | |
|---|---|---|---|---|---|---|---|
| | | | | Content | | | |
| | Dichroic dye | | | of | | | |
| | | Dye | Polymer | polymer | | | |
| Sample | | concentration | material | material | Ratio of | Initial | |
| name | Dye No. | (wt %) | No. | (wt %) | transmissivity | transmissivity | Remarks |
| K | 1-8 | 1.5 | No. 4 | 10 | 8.6 | 80 | Invention |
| L | 1-8 | 1.5 | No. 4 | 5 | 8.2 | 80 | Invention |
| M | 1-8 | 2.0 | No. 4 | 10 | 11.4 | 78 | Invention |
| N | 1-13 | 1.5 | No. 4 | 10 | 7.8 | 82 | Invention |
| O | 1-2 | 2.0 | No. 4 | 10 | 7.6 | 78 | Invention |
| P | 1-8 | 1.5 | No. 9 | 10 | 8.8 | 83 | Invention |
| Q | Y-1 | 1.5 | No. 4 | 10 | 6.7 | 80 | Invention |
| R | 1-8 | 1.5 | None | None | 2.9 | 80 | Comparative |
| | | | | | | | example |
| S | M-1 | 1.5 | None | None | 2.0 | 75 | Comparative |
| | | | | | | | example |
| T | 1-8 | 2.0 | None | None | 3.0 | 74 | Comparative |
| | | | | | | | example |

In the comparative examples, the light modulating materials were prepared in the same manner as in Example 3 below, except that the polymer material was not added, and the results of the evaluation of the comparative examples evaluated in the same manner as in Example 1 are also shown in Table 3. Compared with the light modulating material of the invention, the light modulating material of the comparative examples had a lower ratio of transmissivity and a lower light modulating ability.

The light modulating material of the invention was confirmed to be in a transparent state of high transmissivity when no voltage was applied.

### Evaluation of Light Fastness

Light fastness was evaluated in the light modulating materials of the invention and the light modulating materials of the comparative examples. All light modulating materials were illuminated (300 hours) by Xe lamp (100,000 lux), and the electrical characteristics of the light modulating materials of the invention did not change. In the light modulating materials of the comparative examples, however, it was visually confirmed that the absorption of light was lower in the colored state when voltage was applied. That is, the light modulating materials of the invention presented excellent light fastness.

### Vehicle Mounted Applications

The light modulating materials of the examples of the invention were applied to the inside of the windshield and the inside of the side glass of an automobile by using an adhesive, and it was confirmed that the transparent state and the scattered and colored state could be changed electrically. That is, the light modulating material of the invention was confirmed to be advantageous when applied as a vehicle mounted light modulating material. The light modulating material of the invention was in a transparent state of high transmissivity when no voltage was applied, and it was confirmed that power consumption could be reduced.

### Interior Applications

The light modulating material of the example of the invention was applied to door glass using an adhesive, and it was confirmed that the transparent state and the scattered and colored state could be changed electrically. That is, the light modulating material of the invention was confirmed to be advantageous when applied as a light modulating material for interior use. The light modulating material of the invention was in a transparent state of high transmissivity when no voltage was applied, and it was confirmed that power consumption could be reduced.

### Example 3

A light modulating material of the invention was fabricated in the same manner as in Example 1, except that the host liquid crystal was changed to ZLI-6610 (trade name, manufactured by Merck & Co.), and that the vertically aligned layer was changed to an octadecyl silane coupling agent (manufactured by Shin-Etsu Kagaku Kogyo). The light modulating material of the invention was evaluated in the same way as in Example 1, and a high light modulating ability was confirmed. The light modulating material of the invention was in a transparent state of high transmissivity when no voltage was applied, and it was confirmed that power consumption could be reduced.

### CROSS-REFERENCE TO RELATED APPLICATION

This application claims priority under 35 USC 119 from Japanese Patent Application No. 2006-75241, the disclosure of which is incorporated by reference herein.

What is claimed is:

1. A light modulating material comprising a liquid crystal layer disposed between a pair of transparent electrodes,
wherein the liquid crystal layer comprises: a liquid crystal composition comprising at least one host liquid crystal having negative dielectric anisotropy and at least one dichroic dye; and at least one polymer material,
the liquid crystal composition is vertically aligned when no voltage is applied; and
the transmissivity of incident light of the light modulating material when no voltage is applied is higher than the transmissivity of incident light of the light modulating material when voltage is applied.

2. The light modulating material of claim 1, wherein the host liquid crystal shows a nematic phase.

3. The light modulating material of claim 1, wherein the liquid crystal layer is held between a pair of vertically aligned layers.

4. The light modulating material of claim 1, wherein the polymer material is a siloxane polymer.

5. The light modulating material of claim 1, wherein the polymer material has a mesogen that has a positive dielectric anisotropy and is disposed at a side chain of the polymer.

6. The light modulating material of claim 1, wherein the dichroic dye has a substituent represented by the following Formula (1):
-(Het)ⱼ-{(B¹)ₚ-(Q¹)_{q}-(B²)ᵣ}ₙ—C¹ Formula (1):
wherein Het represents an oxygen atom or a sulfur atom; each of B¹ and B² independently represents an arylene group, a heteroarylene group, or a divalent cyclic aliphatic hydrocarbon group; Q¹ represents a divalent coupler; C¹ represents an alkyl group, a cycloalkyl group, an alkoxy group, a alkoxy carbonyl group, an acyl group, or an acyloxy group; j represents 0 or 1; each of p, q and r independently represents an integer from 0 to 5; n represents an integer from 1 to 3; (p+r)×n is an integer from 3 to 10; when p, q, or r is 2 or more, two or more of B¹, Q¹ and B² may be the same as or different from each other; and when n is 2 or more, two or more of {(B¹)ₚ-(Q¹)_{q}-(B²)ᵣ} may be the same as or different from each other.

7. The light modulating material of claim 1, wherein the dichroic dye comprises an anthraquinone dye or a phenoxazine dye.

8. The light modulating material of claim 1, wherein the light modulating material comprises an anti-reflection film.

9. The light modulating material of claim 1, wherein the light modulating material comprises a barrier layer.

10. The light modulating material of claim 1, wherein the light modulating material comprises an ultraviolet absorption layer.

11. A liquid crystal device comprising a liquid crystal layer disposed between a pair of electrodes comprising at least one transparent electrode,
wherein the liquid crystal layer comprises: a liquid crystal composition comprising at least one host liquid crystal having negative dielectric anisotropy and at least one dichroic dye; and at least one polymer material,
the liquid crystal composition is vertically aligned when no voltage is applied; and
the transmissivity of incident light of the light modulating material when no voltage is applied is higher than the transmissivity of incident light of the light modulating material when voltage is applied.

12. The liquid crystal device of claim 11, wherein the host liquid crystal shows a nematic phase.

13. The liquid crystal device of claim 11, wherein the liquid crystal layer is held between a pair of vertically aligned layers.

14. The liquid crystal device of claim 11, wherein the polymer material is a siloxane polymer.

15. The liquid crystal device of claim 11, wherein the polymer material has a mesogen that has a positive dielectric anisotropy and is disposed at a side chain of the polymer.

16. The liquid crystal device of claim 11, wherein the dichroic dye has a substituent represented by the following Formula (1):
-(Het)ⱼ-{(B¹)ₚ-(Q¹)_{q}-(B²)ᵣ}ₙ—C¹ Formula (1):
wherein Het represents an oxygen atom or a sulfur atom; each of B¹ and B² independently represents an arylene group, a heteroarylene group, or a divalent cyclic aliphatic hydrocarbon group; Q¹ represents a divalent coupler; C¹ represents an alkyl group, a cycloalkyl group, an alkoxy group, a alkoxy carbonyl group, an acyl group, or an acyloxy group; j represents 0 or 1; each of p, q and r independently represents an integer from 0 to 5; n represents an integer from 1 to 3; (p+r)×n is an integer from 3 to 10; when p, q, or r is 2 or more, two or more of B¹, Q¹ and B² may be the same as or different from each other; and when n is 2 or more, two or more of {(B¹)ₚ-(Q¹)_{q}-(B²)ᵣ} may be the same as or different from each other.

17. The liquid crystal device of claim 11, wherein the dichroic dye comprises an anthraquinone dye or a phenoxazine dye.

18. The liquid crystal device of claim 11, wherein the liquid crystal device comprises an anti-reflection film.

19. The liquid crystal device of claim 11, wherein the liquid crystal device comprises a barrier layer.

20. The liquid crystal device of claim 1, wherein the liquid crystal device comprises an ultraviolet absorption layer.
